(19) United States
(12) Patent Application Publication
(10) Pub. No.: US 2005/0026561 A1
(43) Pub. Date: Feb. 3, 2005

(54) Third generation (3g) mobile service over catv network

(76) Inventors: Dan Shklarsky, Hifa (IL); Harel Golombek, Netanya (IL); Mordechai Zussman, Kiriat Bialik (IL)

Correspondence Address: SUGHRUE MION, PLLC, 2100 PENNSYLVANIA AVENUE, N.W., SUITE 800, WASHINGTON, DC, 20037, US

(21) Appl. No.: 10/474,807

(22) PCT Filed: Apr. 11, 2002
(86) PCT No.: PCT/US02/08254

Related U.S. Application Data
(60) Provisional application No. 60/283,382, filed on Apr. 13, 2001.

(51) Int. Cl. H04B 7/15

(52) U.S. Cl. 455/11.1; 455/7

(57) ABSTRACT

A CATV network (141) designed to distribute television and other services in using radio frequencies below a certain frequency (typically 860 HMz) is modified to add a secondary transmission bi-directional capability above this frequency. The secondary bi-directional network (101, 102) is established by adding filters to separate modified mobile-communications frequencies (above 860 MHz) from conventional CATV services (below 860 MHz). Third generation (3G) networks and second generation (2G) networks are together merged with CATV networks. Cable TV networks are used to provide in-building access for 3G and 2G mobile radio terminals, in a mobile radio network. A Cable Mounted Third Generation Module acts as a transmit receive antenna and frequency translator for the 3G signals.

### BACKGROUND OF THE INVENTION

1. Field of the Invention

The invention relates to a new topology for Third Generation (3G) cellular radio networks like UMTS, CDMA2000 and the like, and a method which improves the in-building coverage and the total available capacity of Third Generation cellular or mobile radio network.

In particular, the invention relates to an extension to conventional mobile radio networks using cable-TV or HFC (Hybrid Fiber Coax) networks (referred to as CATV networks, hereafter). To be even more specific, the present invention involves how CATV networks are merged into mobile radio networks to provide improved voice & data services and coverage, while enhancing network capacity; how CATV netowrks are used to provide in-building access for 3G mobile radio terminals, in a mobile radio network; how 3G signals such as those according to the UMTS air interface standard, are combined together with Second Generation (2G) signals such as those according to the GSM900 air interface, and are carried together on the CATV system, without interfering to each other, or the CATV service; and how new applications that result from the synergy of a 3G mobile communication system and terminals and some elements of a CATV system like home TV and/or the set-top box can be realized.

2. Related work.

The basic theory by which mobile radio and cellular networks operate is well known. A 3G mobile radio network is an example of such a network. Geographically distributed network access points, each defining cells of the network, characterize cellular radio networks. The geographically distributed network access points are typically referred to as base stations BS or base transceiver stations BTS, and includes transmission and reception equipment for transmitting signals to and receiving signals from mobile radio terminals (MT). Each cell (or sector) is using only part of the total spectrum resources, but the same network resources (either frequency or code), may be used many times in different cells, as long as the cell to cell distance is far enough. This is known as a reuse factor. The cells may be subdivided further, thus defining microcells. Each such microcell provides cellular coverage to a defined (and usually small) area. Microcells are usually limited in terms of their total available capacity.

One problem needing to be solved is the inability of present frequency or code reuse techniques (sectorization and cell-area subdivision) to deal with the “third dimension” problem. Cellular networks have no means to deal with the problem of user terminals at higher-than-usual elevations, e.g. upper floors of high-rise office and residential buildings. The overall demand for mobile services had caused cellular network operators to develop an intensive network of BTSs in urban areas. This has improved spectrum utilization (increased network capacity) at ground level, but has aggravated the problem in high-rise buildings where MTs now ‘see’ several BTSs on the same frequency or code.

Cells in a cellular radio network are typically connected to a higher-level entity, which may be referred to as a mobile switching center (MSC), which provides certain control and switching functions for all the BTS, connected to it. The MSCs are connected to each other, and also to the public switched telephone network (PSTN), or may themselves have such a PSTN interface.

The conventional implementation of a 3G radio network has had some important limitations. In particular, it is necessary in a conventional 3G mobile radio network to build numerous base stations to provide the necessary geographic coverage and to supply enough capacity for high-speed data applications. The 3G base stations require an important amount of real estate, and are very unsightly.

Another limitation is that, since cellular towers are expensive, and require real estate, it is economically feasible to include in a network only a limited number of them. Accordingly, the size of cells might be quite large, and it is therefore necessary to equip the mobile radio terminals with the ability to radiate at high-power so as to transmit radio signals strong enough for the geographically dispersed cellular towers to receive.

As the cell radius becomes larger, the average effective data rate per user decreases accordingly and the high-speed data service might deteriorate.

Yet another limitation to cellular radio networks as conventionally implemented is that the cellular antennas are typically located outside of buildings, even though it would be highly beneficial to provide cellular service inside buildings. The penetration of cellular signals for in-building applications requires high power sites, or additional sites or repeaters to overcome the inherent attenuation inherent with in-building penetration. Because the towers are located outside of buildings, it is difficult for mobile radio terminals to transmit signals strong enough to propagate effectively from inside of the building to outside of the building. Therefore, the use of 3G terminals inside buildings results in reduced data rate and consumes substantial amount of the limited battery time.

Yet another limitation of 3G radio networks as conventionally implemented is the inherent limited capacity of each and every BTS to provide voice and data service. This capacity shortage is due to the way the spectrum resources are allocated to each BTS. To provide for reasonable voice and data quality, each BTS can use only a part of the total spectrum resources owned by the cellular operator. Other BTSs could reuse the same part of the spectrum resources as a given BTS, but a pattern of geographic dispersion would have to be respected. This is called a reuse codes pattern for CDMA technologies like UMTS and CDMA2000.

One way to mitigate the above-identified disadvantages of 3G networks is by using the access part of a CATV network for the benefit of a cellular radio network. The CATV network is near-ubiquitous, in most urban areas. The delivery of 3G signals directly to the mobile subscriber's premises, by using the CATV network, allows reducing the reuse factor and hence brings an increase of an order of magnitude in the network's available capacity. This is due to the fact that the propagation conditions are greatly improved by using the CATV as an access path inside buildings, instead of transmitting from outdoor towers.

The prior approaches for carrying wireless signals over the CATV network include re-arranging or re-packaging the original radio signal to fit into the existing CATV standard frequencies (5-45 MHz and 50-750/860 MHz) and channels. This is typically done by active elements, which up- and down-convert the wireless frequencies to match the known standard CATV operational frequencies in the standard CATV upstream and downstream frequencies. Using the standard CATV channels reduces the available bandwidth of the CATV operators in providing video, data and voice according the common CATV standards like DOCSIS and DVB.

Such approaches have all been disadvantageous, however. In particular, if one wishes to re-arrange and re-pack the full UMTS frequency band (1920-1980 MHz, 2110-2170 MHz) into the standard CATV channels, one finds that the UMTS uplink bandwidth (60 MHz) is too large, and hence impossible for the CATV upstream (40 MHz) to carry. Even if smaller UMTS bandwidth were to be carried over the CATV upstream, this would dramatically reduce the scarce upstream CATV resource.

Some patent documents representing such disadvantageous approaches are now summarized.

U.S. Pat. Nos. 5,802,173 and 5,809,395 (related patents) describe a radiotelephony system in which cellular signals are carried over a CATV network. However, uplink cellular communications are frequency converted to “in the range 5 to 30 Mhz”. Such a conversion is necessary because the CATV network is normally frequency-divided into two bands: a high band which handles downstream transmission (head-end to hub to subscriber) and a low band which handles upstream transmission (subscriber to hum to head end). In other words, any upstream signals or communications over about 45 Mhz are filtered out by the CATV network itself as a part of the normal operation of the network. Under the '173 approach, upstream communications all must be fit into the low band (i.e., in “a portion of the frequency spectrum allocated in the CATV system for upstream communications”).

U.S. Pat. No. 5,828,946 describes a CATV based wireless communications scheme. Under the '946 approach, to avoid multiple outdoor cellular receptions from causing noise over the CATV network, only the signals received at a sufficient power level are converted and sent upstream.

U.S. Pat. No. 5,822,678 acknowledges that the frequency-divided nature of CATV networks is a problem. In particular, the '678 patent teaches that the limited bandwidth available “within the frequency band of five megahertz to 40 megahertz” poses “a problem with using the cable plant to carry telephonic signals.” To solve this problem, the '678 approach is that “currently existing frequency allocations for cable television are redefined.” That is to say, the division between high and low bands in a CATV network is moved from about 40 Mhz to several hundred megahertz higher. This simplistic approach is highly disadvantageous because it requires replacement of substantial amounts of equipment in any CATV network. Such an expensive approach has not yet been adopted for actual use.

U.S. Pat. No. 5,638,422, like the previously mentioned documents, teaches carrying uplink cellular communications “the return path of the CATV system, i.e. 5 to 30 Mhz, for telephone traffic in the return direction.” Furthermore, downlink cellular communications are disadvantageously carried in “the forward spectrum, i.e. 50 to 550 Mhz of the CATV system”. This interferes with CATV signals, and is problematic for the CATV operator, who must move existing programming to other parts of the spectrum to make room for downlink cellular signals.

U.S. Pat. No. 6,223,021 teaches how to use programmable remote antenna drivers to provide augmented cellular coverage in outdoor areas. For example, during morning rush hour, the remote antennas are tuned to one frequency set and to another during evening rush hour. Thus, outdoor communications can be flexibly augmented. The remote antenna drivers and their antennas are hung from outdoor CATV cables. The '021 patent does not describe how to solve the problem of limited upstream bandwidth for uplink cellular communications.

U.S. Pat. No. 6,192,216 describes how to use a gain tone from remote antenna locations, sent over a CATV network, to determine a proper level of signal at which each remote antenna location should transmit.

U.S. Pat. No. 6,122,529 describes the use of outdoor remote antennas and remote antenna drivers to augment an existing cellular coverage area, but only in areas where outdoor cellular antennas provide no coverage. The signal of a given BTS sent to a cellular antenna tower is simulcast over the remote antennas to overcome “blind” areas.

U.S. Pat. No. 5,953,670 describes how to use remote antenna drivers as well, but adopts the above-identified approach of sending uplink cellular communications in the low CATV band.

### SUMMARY OF THE INVENTION

It is an object of the invention to overcome the above-identified limitations of the present mobile networks, and the above-identified disadvantages of the related attempts to integrate cellular radio networks with CATV networks.

According to one aspect of the invention, there is provided an extension to 3G mobile radio networks whereby a CATV network is enabled to transport mobile radio traffic. According to another aspect of the invention, there is provided a CATV network capable of handling traffic in UMTS and GSM 900 MHz simultaneously without degrading the CATV services or the UMTS and GSM900 services.

To achieve the above and other objects of the invention, the CATV network functions as an access element of the 3G or 3G/2G network, namely in its RF propagation-radiation section. According to the system described herein, the capabilities of existing CATV networks are substantially preserved, but the 2G/3G mobile radio terminals do not have to be modified. That is to say, the signals sent according to the radio communications protocol traverse the CATV network on non-utilized CATV frequencies (typically 905-1155 MHz).

The radio frequencies and channel structures of the 3G, UMTS, GSM900 and the CATV networks are different. According to the invention, the CATV network is modified so as to permit the propagation of the RF signals of the mobile radio network which are frequency translated to propagate over the CATV system in, e.g., the 905-1155 MHz band.

This frequency band (905-1155 MHz) is not used at all by the CATV operators, but it may be used to carry 3G or 2G/3G signals by properly upgrading the CATV infrastructure.

A conventional CATV network is a two-way network having a tree and branch topology with cables, amplifiers, signal splitters/combiners and filters. According to one aspect of the invention, the cables and signal splitters/combiners are not modified, but the other elements are. Thus, new components for a CATV system that permit overlaying a multiband bi-directional communication system are described. The modified components allow both types of signals (the CATV up and down signals and the 2G/3G voice+data up and down signals) to be carried by the network simultaneously in a totally independent manner (any cross-coupling can be a source of an unacceptable interference).

It is important to note that the cables (fiber and coaxial) used in CATV networks are not severely limited as to bandwidth. Practical CATV networks are bandwidth limited by the bandwidth and signal loading limitations of practical repeater amplifiers. CATV networks now use filters to segment cable spectrum into two bands—one for ‘upstream’ communications and the other for downstream ‘communications’. By adding duplexers and filters to provide additional spectrum segmentation it allows additional amplifiers to handle upstream and downstream cellular network traffic.

According to another aspect of the invention, there is provided a Cable Mounted Third Generation Module (CMTGM, see FIG. 4). The CMTGM is a component that acts as a transmit/receive antenna and frequency translator for the 3G or 2G/3G signals (the downlink includes controlled attenuation) and as a cable input/output unit for the cable network. Most of the existing CATV video signals are already limited to frequencies under 750 MHz (some CATV networks goes up to 860 MHz) while the 3G and 2G signals operate above this limit and are translated to above this limit. The different types of signals can coexist within the same coaxial cable due to this fact.

The CATV network is thus modified in a way that permits the CATV transmissions to be maintained in their original format and frequency assignments. The modifications to the CATV network itself can be made using only linear components such as filters and amplifiers. The modifications are simple, robust and affordable.

### BRIEF DESCRIPTION OF THE DRAWING FIGURES

FIG. 1 shows the frequency assignment of a dual cellular 2G/3G service (UMTS and GSM900), before and after the frequency conversion.

FIG. 2 shows the frequency assignment of a 3G (UMTS) only service, before and after the frequency conversion.

FIG. 3 shows an upgraded. Cellular Cable Network (CCN) according to one embodiment of the invention.

FIG. 4 shows a simplified schematic view of a Cable Mount Third Generation Module (CMTGM) for UMTS and GSM900 air interfaces according to an embodiment of the invention.

FIG. 5 shows a simplified schematic view of a Cable Mount Third Generation Module (CMTGM) for UMTS air interface according to an embodiment of the invention.

FIG. 6 shows a simplified schematic view of a Cellular Transport Module (CETM) (repeater), for UMTS and GSM900 air interfaces, according to an embodiment of the invention.

FIG. 7 shows a simplified schematic view of a Cellular Transport Module (CETM) (repeater), for UMTS air interface, according to an embodiment of the invention.

FIG. 8 shows, in simplified schematic form, a Cellular Entrance Module (CEEM), for UMTS and GSM900 air interfaces, according to an embodiment of the invention

FIG. 9 shows, in simplified schematic form, a Cellular Entrance Module (CEEM), for UMTS air interface, according to an embodiment of the invention.

FIG. 10 shows, in simplified schematic form, a Network Coupling Duplexer (NCD). This duplexer passive device can combine (or separate) the CATV signals and 2G/3G signals, into (or from) one RF port.

### DETAILED DESCRIPTION OF THE PREFERRED EMBODIMENTS

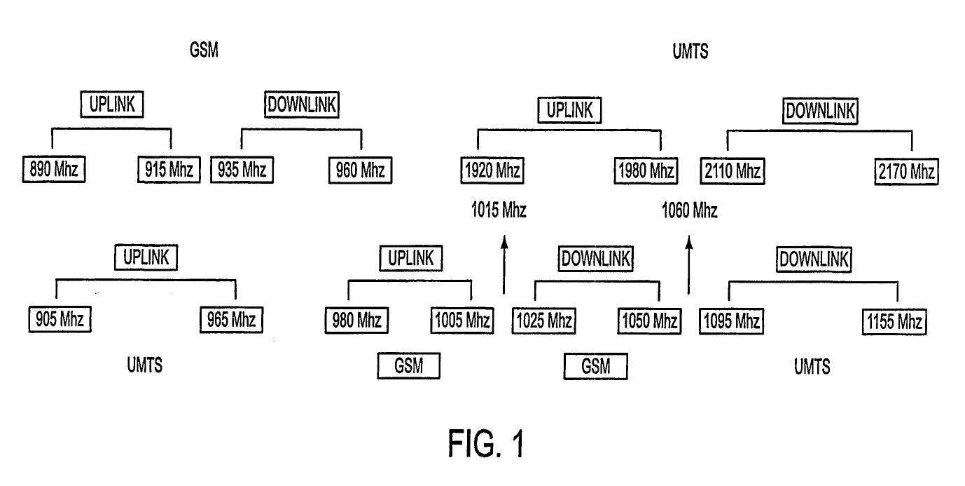

FIG. 1 shows a frequency assignment by which the standard UMTS and GSM900 uplink and downlink frequencies are shifted to the 905-1155 Mhz band.

In addition, two pilot tones at 1015 Mhz and 1060 Mhz are added in order to serve as local oscillators during the reverse translation, at the customer's site. The 1015 Mhz is used to translate back the UMTS frequencies, and the 1015 Mhz and 1060 Mhz pilots are used together to create a 90 Mhz pilot, by a non-linear mixing {2*(1060-1015)=90}. The 90 Mhz pilot is used to translate back the GSM900 to their original standard allocation.

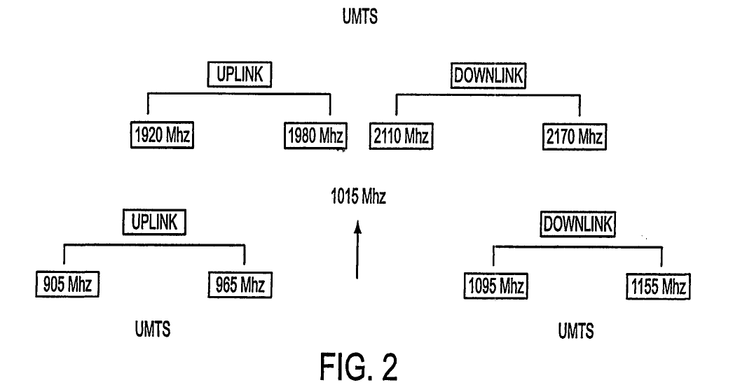

FIG. 2 shows a frequency assignment by which the standard UMTS uplink and downlink frequencies are shifted to the 905-1155 Mhz band. In addition, a pilot tone at 1015 Mhz serves as a local oscillator during the reverse translation, at the customer's site. The 1015 Mhz carrier is used to translate back the UMTS frequencies.

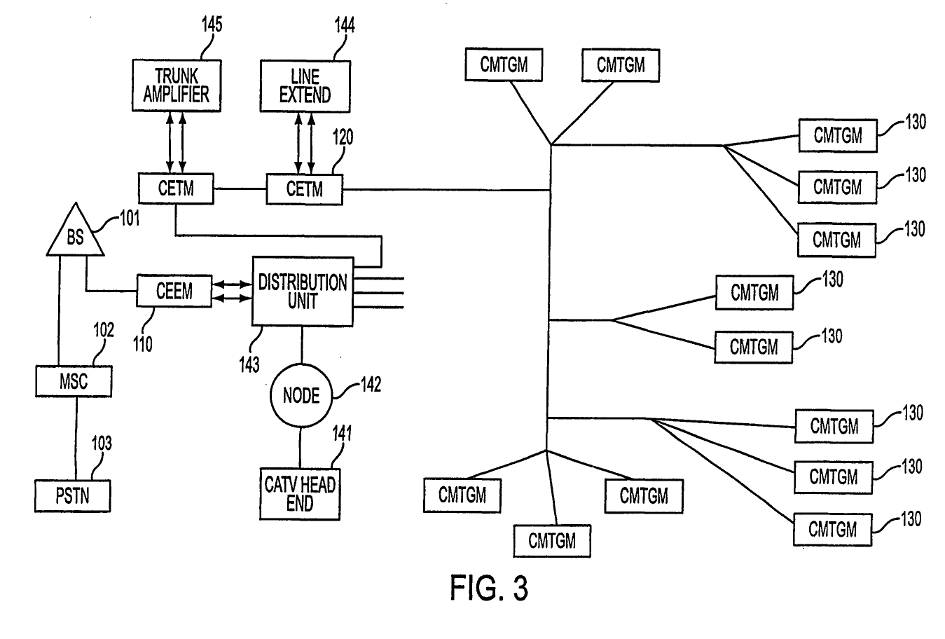

FIG. 3 shows a typical block diagram of an upgraded CATV network that can support the delivery of 2G and 3G signals.

The CEEM is the interface between the 3G or 2G/3G network and the cable network. Signals from the BS entering at the CEEM are first frequency translated to within the 905-1155 MHz band and distributed through the cable network.

The CETM, also referred to as a bypass device, transports the 3G signal through the cable network. The CETM is installed at any active component of the cable network, such as trunk amplifiers, line extenders and distribution modules, so as to bypass such active points in the network.

The CMTGM is the interface between the upgraded cellular cable network and the 3G terminal (end user) unit at the customer premises. It first translates back the frequencies according to the specific 3G air-interface standard in use (1920-1980 MHz &2110-2170 MHz in the case of the UMTS air interface).

More particularly, CATV signals from the CATV head end 141 are carried out through an optical link to the optical node 142 and through coaxial cable to the distribution amplifier 143. 3G signals (both uplink and downlink) are carried to/from the BTS 101 to the CEEM 110 which functions as the interface of the cellular signal to the upgraded cellular cable network.

The CEEM 110 enables the combination of both the cellular and the cable signals to be carried through the network. The combined signals from the CEEM 110 are connected back to the distribution amplifier 143 and the combined cellular and cable signals are carried forward through the network to the subscriber premises. The signals traveling from the distribution amplifier 143 to the CMTGM 130 past line extenders 144 and trunk amplifiers 145 through the CETM 120 to the CMTGM 130.

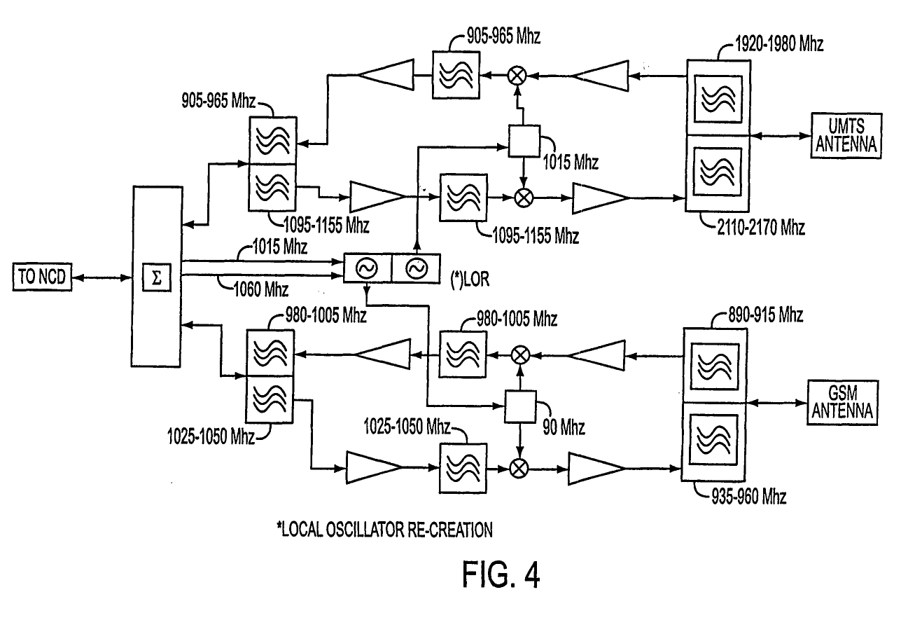

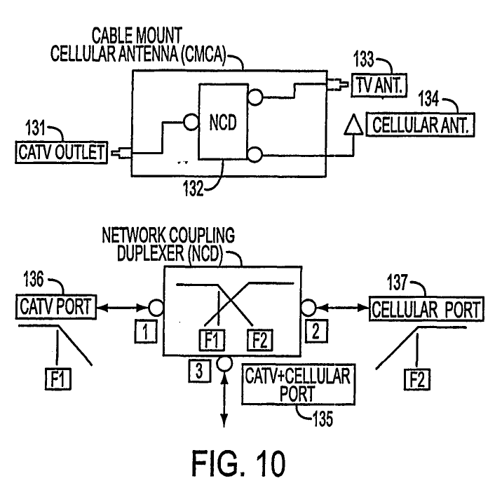

FIG. 4 shows a Cable Mount Third Generation Module (CMTGM) for UMTS and GSM system. The combined modified 2G/3G (UMTS/GSM) signals and cable signal enters at the CATV outlet. The 2G/3G and cable signals are differentiated at the Network Coupling Duplexer (NCD) (see FIG. 10). The modified 2G/3G signals enter the frequency translator unit, which is the CMTGM. The CMTGM converts back the frequency to being able to communicate with a standard 3G or 2G or 2G/3G terminal.

In order to convert the frequencies back to the standard UMTS or GSM900 frequencies, precise local oscillators are needed. The 1015 MHz CW signal is injected to the system at the CEEM, and is carried along the path to the CMTGM. The CMTGM uses this 1015 MHz CW signal to convert back the UMTS up and down links. To convert GSM900 signals back to their original standard frequencies, a 90 MHz CW signal is required. This 90 MHz CW signal is reproduced at the CMTGM by mixing the 1015 MHz and 1060 MHz CW signals that are injected at the CEEM and carried along the CATV network. By imposing these two CW signals on a non-linear device (like a mixer), a 90 MHz signal is produced {2×(1060-1015)}.

This method of transporting the local oscillator frequencies along the network to the CMTGM eliminates the need for using precise and expensive frequency sources in the CMTGM. This can reduce the complexity and cost of the CMTGM for the subscriber.

The antenna that connects to the CMTGM transmits the 3G or 2G signals, to be received by the customer 3G or 2G or 2G/3G unit. The TV signals are connected to the TV set (or set-top-box) through the CATV port of the NCD (FIG. 10).

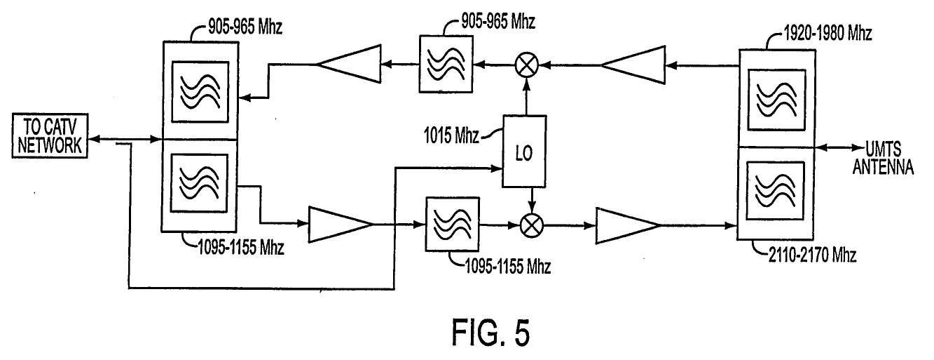

FIG. 5 is a block diagram for a UMTS only end-user conversion unit. This is a sub-set of the previous CMTGM without the GSM section. Only one CW pilot (1015 Mhz) is needed to convert back the UMTS signals.

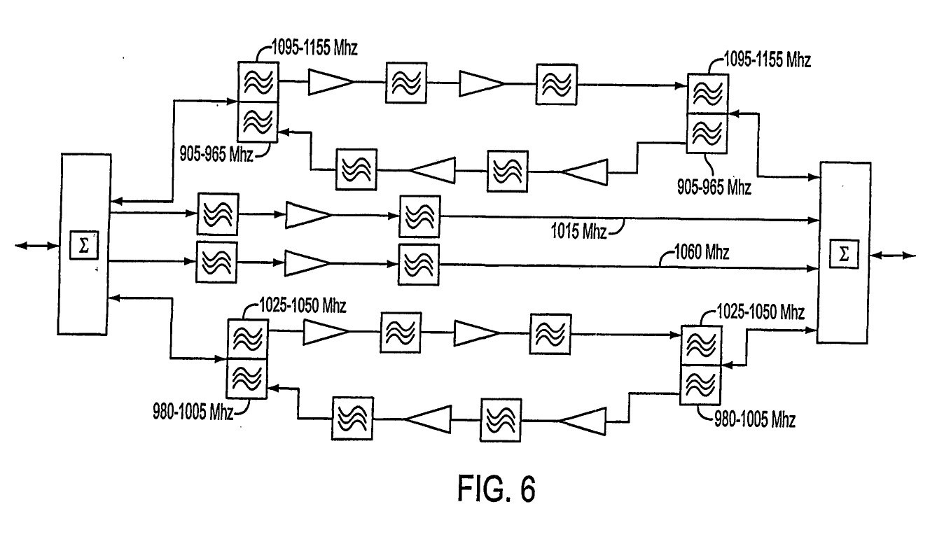

FIG. 6 shows a block diagram of the Cellular Transport Module CETM for a dual UMTS/GSM900 system. This by-pass device is a bi-directional amplifier repeater that amplifies the uplink and downlink signals of both UMTS and GSM900. It also amplifies the two CW pilots at 1015 Mhz and 1060 Mhz. The bi-directional amplification of the cellular signals is done at each point on the CATV network where a CATV amplifier is installed, since the standard CATV amplifier cannot handle the cellular uplink and downlink signals.

According to a specific embodiment of the invention, the CETM may be installed even when an active component like a CATV amplifier is not present. That is, the CETM may be employed in situations in which only the cellular signals need to be amplified.

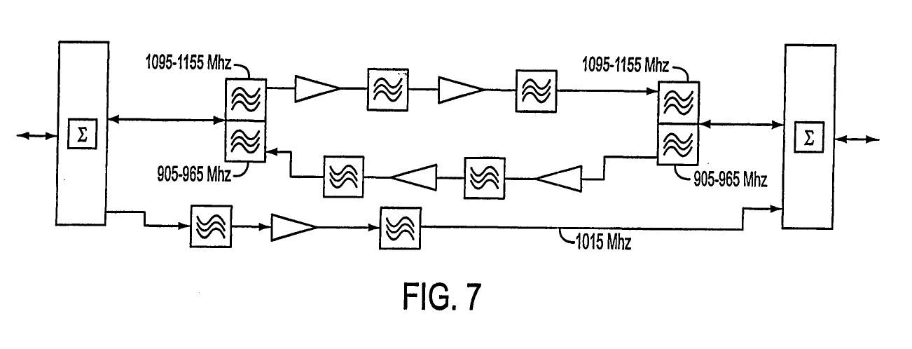

FIG. 7 is a block diagram of a CETM for a UMTS only system. This is a sub-set of the CETM in FIG. 6. In the UMTS only case, there is only one pilot CW at 1015 MHz to be amplified.

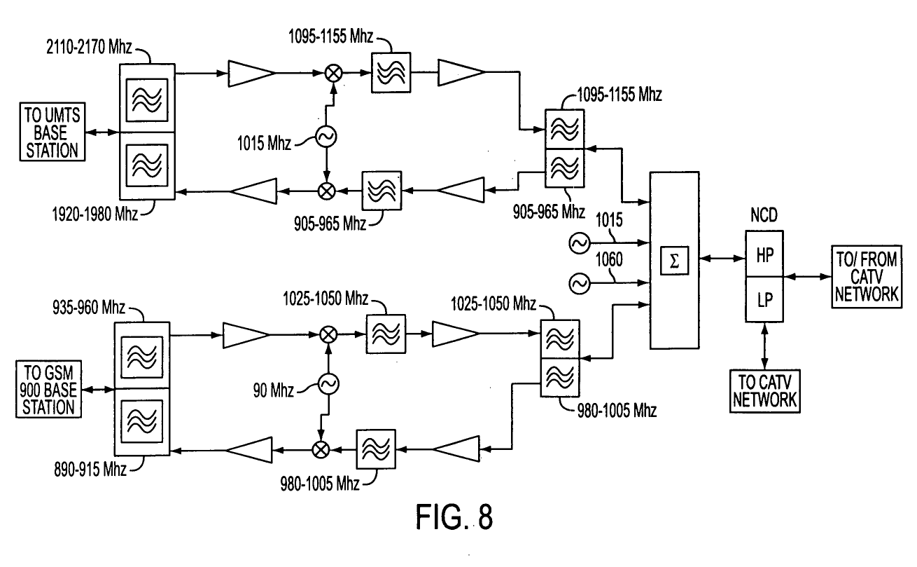

FIG. 8 shows the Cellular Entrance Module (CEEM) for a dual UMTS/GSM900 system. The CEEM is the interface between the UMTS and GSM900 networks and the cable TV network. The 3G mobile signals from the BTS are translated and carried through the CEEM and combined through the HP/LP filters to the cable signals to be carried through the network.

To explain, the CATV signals from the optical node 142 (FIG. 3) are connected to the CEEM, through point 136 (FIG. 10), directly to the distribution amplifier 143 (FIG. 3). The cellular signals to/from the BS are connected to the CEEM trough point 137 (FIG. 10). The input duplexer in the CEEM (FIG. 8) differentiates between the uplink and downlink signals to be amplified by the amplifiers to balance the power budget along the pass.

The cellular signals are then frequency converted to fit within the 905-1155 Mhz band. After the frequency conversion the signals are amplified again and are connected to the High Pass/Low Pass duplexer (NCD). The output from the NCD is transferred back to the distribution amplifier 143 (see FIG. 3) to be distributed through the entire upgraded cable network.

In addition, two very accurate CW signals at 1015 MHz and 1060 MHz, are separately produced and inserted into the network. These signals are used by the CMTGM to convert the cellular frequencies to their standard allocation, for communication with the customer mobile terminal or mobile phone.

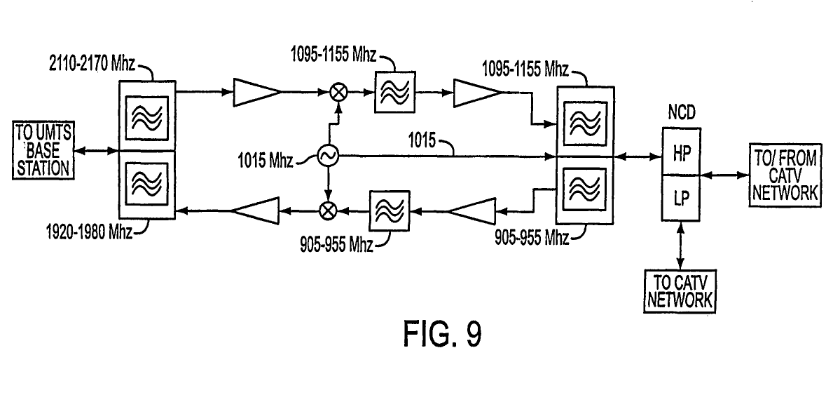

FIG. 9 shows the block diagram of a CEEM for a UMTS only system. It is a subset of the previous UMTS/GSM900 CEEM. In this case only one pilot CW at 1015 MHz is injected into the system.

FIG. 10 shows the Network Coupling Duplexer (NCD). This duplexer can combine or un-combine the CATV and modified cellular signals. The cutoff frequency F1 of the CATV port (131,136) is either 750 MHz or 860 Mhz, and is chosen in accordance with the specific CATV system. The cutoff frequency F2 of the cellular port (134,137) is 905 Mhz The common port (131,135) carries both CATV and cellular signals.

One familiar with this field will understand that the use of the equipment and method described herein constitutes a method for enhancing the throughput of a 3G and 2G/3G mobile radio network. With indoor cells accessed through the cellular cable network, the power of the transmitting mobile units indoors can be very low. This, coupled with the inherent attenuating effects that occur within buildings, combine to make it possible for a much better data service in indoor cells.

The various embodiments and aspects of the invention help overcome coverage and capacity constraints now faced by operators of 3G mobile radio networks. By mitigating these coverage constrains, the cost of providing excellent radio coverage is reduced and service levels are improved. CATV system operators will have a potential new source of income. New service packages are possible in which CATV and mobile radio terminal service are combined.

Although the invention has been described above using some concrete examples for the sake of explanation, it will be appreciated that these examples and the enclosed figures are not intended to limit the scope of the invention, which is to be determined based on the appended claims. Many minor modifications and changes will occur to those familiar with this field, and may be made without departing from the scope and spirit of the invention.

For example, the invention is not limited to any particular 2G or 3G system, but applies to any sort of wireless communication, presently known hereafter developed. Moreover, although specific frequencies have been mentioned for the sake of concrete examples, any other frequency range can be envisioned. That is to say, if the CATV network becomes able to handle frequencies far in excess of those today used, it will be possible still to use the invention in such a system by shifting the original frequency wireless RF cellular signals to a desired band above the CATV signals.

1. A method for providing bidirectional wireless RF cellular communication through a CATV network, comprising:
providing a bypass device at an active point in a CATV network; and
communicating frequency shifted wireless RF cellular signals and CATV signals, over the CATV network, between an access point of the CATV network and an indoor termination point of the CATV network;
wherein the CATV signals are communicated via the active point and the shifted wireless RF cellular signals are communicated via the bypass device.

2. The method for providing bidirectional wireless RF cellular communication through a CATV network according to claim 1, further comprising, at the indoor termination point of the CATV network:
receiving shifted downlink wireless RF cellular signals from the CATV network;
converting the shifted downlink RF cellular signals to original frequency downlink wireless RF cellular signals;
outputting the original frequency downlink wireless RF cellular signals to an antenna;
receiving original frequency uplink wireless RF signals from the antenna;
converting the original frequency uplink wireless RF signals to shifted uplink wireless RF signals; and
outputting the shifted uplink wireless RF signals to the CATV network.

3. The method for providing bidirectional wireless RF cellular communication through a CATV network according to claim 2, further comprising, at the indoor termination point of the CATV network, communicating CATV signals between the CATV network and at least one CATV device by coaxial cable.

4. The method for providing bidirectional wireless RF cellular communication through a CATV network according to claim 3, wherein the at least one CATV device is one or more of a TV, a set top box, and a cable modem.

5. The method for providing bidirectional wireless RF cellular communication through a CATV network according to claim 2, further comprising communicating the original frequency wireless RF signals over a common air interface of the cellular network.

6. The method for providing bidirectional wireless RF cellular communication through a CATV network according to claim 5, wherein the shifted uplink wireless RF signals have a frequency above 905 MHz.

7. The method for providing bidirectional wireless RF cellular communication through a CATV network according to claim 5, wherein the shifted downlink wireless RF signals have a frequency above 905 MHz.

8. The method for providing bidirectional wireless RF cellular communication through a CATV network according to claim 5, wherein the original frequency wireless RF signals are shifted to a band higher in frequency than the CATV signals.

9. The method for providing bidirectional wireless RF cellular communication through a CATV network according to claim 8, wherein the band is 905-1155 Mhz.

10. The method for providing bidirectional wireless RF cellular communication through a CATV network according to claim 5, wherein the common air interface of the cellular network is a 3G interface.

11. The method for providing bidirectional wireless RF cellular communication through a CATV network according to claim 2, further comprising, at the access point of the CATV network:
receiving shifted uplink wireless RF cellular signals from the CATV network;
converting the shifted uplink RF cellular signals to original frequency uplink wireless RF cellular signals;
outputting the original frequency uplink wireless RF cellular signals to a BTS;
receiving original frequency downlink wireless RF signals from the BTS;
converting the original frequency downlink wireless RF signals to shifted downlink wireless RF signals; and
outputting the shifted downlink wireless RF signals to the CATV network.

12. The method as set forth in claim 11, wherein the bypass device performs the steps of:
receiving, as a coupled signal, the CATV signals and the frequency shifted wireless RF cellular signals;
differentiating between the CATV signals of the coupled signal and the frequency shifted wireless RF cellular signals of the coupled signal;
passing the CATV signals of the coupled signal through the active component of the CATV network;
passing only the frequency shifted wireless RF cellular signals of The coupled signal around the active component of the CATV network; and
after the passing steps, recombining the CATV signals with the frequency shifted wireless RF cellular signals to provide a signal for further communication over the CATV network.

13. The method as set forth in claim 11, further comprising:
injecting, at the access point of the CATV network, one or more pilot continuous wave (CW) frequencies for communication to the indoor termination point; and
performing reverse frequency translation at the indoor termination point using the one or more pilot CW frequencies, to convert the shifted downlink RF cellular signals and to convert the original frequency uplink wireless RF signals.

14. The method as set forth in claim 13, wherein the one or more pilot CW frequencies includes only one pilot CW frequency.

15. The method as set forth in claim 13, wherein the one or more pilot CW frequencies includes two pilot CW frequencies.

16. The method as set forth in claim 13, further comprising:
using the one or more pilot CW frequencies for creating one or more corresponding local oscillator frequencies; and
using the local oscillator frequencies to convert the shifted downlink RF cellular signals and to convert the original frequency uplink wireless RF signals.

17. The method as set forth in claim 16, wherein the creating of the one or more corresponding local oscillator frequencies is performed using non-linear mixing.

18. The method as set forth in claim 13, wherein the bypass device amplifies the one or more pilot CW frequencies in only the direction from the access point toward the indoor termination point.

19. A system for simultaneously communicating Third Generation (3G) cellular traffic and Second Generation (2G) traffic over a cable television (CATV) network, comprising:
a Cellular Entrance Module (CEEM) at an access point of the CATV network, receiving original downlink signals, including original 3G downlink signals and original 2G downlink signals, and shifting the original downlink signals to a frequency band higher than television signals of the CATV network to provide shifted cellular signals, including shifted 3G downlink signals and shifted 2G downlink signals;
a Cable Mount Third Generation Module (CMTGM) at an indoor termination point of the CATV network, receiving original uplink signals, including original 3G uplink signals and original 2G uplink signals, and shifting the original uplink signals to a frequency band higher than television signals of the CATV network to provide shifted cellular signals, including shifted 3G uplink signals and shifted 2G uplink signals; and
a Cellular Transport Module (CETM) at an active component of the CATV network, the shifted cellular signals being communicated over the CATV network between the CEEM and CMTGM via the CETM.

20. The system for simultaneously communicating 3G and 2G traffic according to claim 19, wherein some of the original cellular signals are received using frequencies in accordance with one or more of the UMTS standard and the GSM900 standard.

21. The system for simultaneously communicating 3G and 2G traffic according to claim 19, wherein the frequency band higher than the television signals of the CATV network is a band of 905-1155 Mhz.

22. The system for simultaneously communicating 3G and 2G traffic as set forth in claim 19, wherein the CEEM performs the steps of:
receiving downlink CATV signals from the CATV network;
the shifting of the original 3G downlink signals to provide the shifted 3G downlink signals and of the original 2G downlink signals to provide the shifted 2G downlink signals;
coupling the downlink CATV signals, the shifted 3G downlink signals, and also the shifted 2G downlink signals to provide a coupled downlink signal;
transporting the coupled downlink signal through the CATV network;
receiving a coupled uplink signal from the CATV network;
decoupling the coupled uplink signal to provide uplink CATV signals and the shifted cellular signals;
shifting the shifted 3G uplink signals to provide restored 3G uplink signals corresponding in frequency to the original 3G uplink signals, and shifting the shifted 2G uplink signals to provide restored 2G uplink signals corresponding in frequency to the original 2G uplink signals;
transporting the uplink CATV signals to the CATV network; and
transporting the restored 3G uplink signals and the restored 2G uplink signals to the cellular network.

23. The system for simultaneously communicating 3G and 2G traffic as set forth in claim 22, wherein the CMTGM performs the steps of:
receiving uplink CATV signals;
the receiving of the original 3G uplink signals and the original 2G uplink signals over a bidirectional antenna;
the shifting of the original 3G uplink signals to provide the shifted 3G uplink signals and the shifting of the original 2G uplink signals to provide the shifted 2G uplink signals;
coupling the uplink CATV signals, the shifted 3G uplink signals, and the shifted 2G uplink signals to provide a coupled uplink signal;
transporting the coupled uplink signal through the CATV network;
receiving the coupled-downlink signal from the CATV network;
decoupling the coupled downlink signal to provide downlink CATV signals, the shifted 3G downlink signals, and the shifted 2G downlink signals;
shifting the shifted 3G downlink signals to provide restored 3G downlink signals corresponding in frequency to the original 3G downlink signals, and shifting the shifted 2G downlink signals to provide restored 2G downlink signals corresponding in frequency to the original 2G downlink signals;
transporting the downlink CATV signals to a television signal receiver, and
transmitting the restored 3G downlink signals and the restored 2G downlink signals over the bidirectional antenna.

24. The system for simultaneously communicating 3G and 2G traffic as set forth in claim 23, further comprising:
injecting, at the CEEM, one or more pilot continuous wave (CW) frequencies in the coupled downlink signal; and
performing reverse frequency translation using the one or more pilot CW frequencies, at the CMTCM, to perform the shifting of the shifted 3G and 2G downlink signals and the shifting of the original 3G and 2G uplink signals.

25. The system for simultaneously communicating 3G and 2G traffic as set forth in claim 24, wherein the one or more pilot CW frequencies includes only one pilot CW frequency.

26. The system for simultaneously communicating 3G and 2G traffic as a set forth in claim 24, wherein the one or more pilot CW frequencies includes two pilot CW frequencies.

27. The system for simultaneously communicating 3G and 2G traffic as set forth in claim 24, wherein:
the CMTGM includes a local oscillator recreation unit receiving and using the one or more pilot CW frequencies for creating one or more corresponding local oscillator frequencies, and
the local oscillator frequencies are used to perform the shifting of the shifted 3G downlink signals to provide the restored 3G downlink signals and the shifting of the shifted 2G downlink signals to provide the restored 2G downlink signals.

28. The system for simultaneously communicating 3G and 2G traffic as set forth in claim 27, wherein the creating of the one or more corresponding local oscillator frequencies is performed using non-linear mixing.

29. The system for simultaneously communicating 3G and 2G traffic as set forth in claim 23, wherein the CETM performs the steps of:
receiving, as a coupled signal, one of the coupled uplink signal and the coupled downlink signal;
differentiating between CATV signals of the coupled signal and shifted 3G and 2G signals of the coupled signal;
passing the CATV signals of the coupled signal through the active component of the CATV network;
passing the shifted 3G and 2G signals of the coupled signal around the active component of the CATV network; and
after the passing steps, recombining the CATV signals of the coupled signal with the shifted 3G and 2G signals of the coupled signal to provide a signal for transmission over the CATV network.

30. The system for simultaneously communicating 3G and 2G traffic as set forth in claim 29, further comprising:
injecting, at the CEEM, one or more pilot continuous wave (CW) frequencies in the coupled downlink signal; and
performing reverse frequency translation using the one or more pilot CW frequencies, at the CMTCM, to perform the shifting of the shifted 3G and 2G downlink signals and the shifting of the original 3G and 2G uplink signals.

31. The system for simultaneously communicating 3G and 2G traffic as set forth in claim 21, wherein the CETM amplifies the one or more pilot CW frequencies in only the direction from the CEEM toward the CMTGM.
